(19) United States
(12) Patent Application Publication
(10) Pub. No.: US 2023/0072662 A1
(43) Pub. Date: Mar. 9, 2023

(54) THERMAL MANAGEMENT SYSTEM FOR VEHICLE

(71) Applicants: HYUNDAI MOTOR COMPANY, Seoul (KR); KIA CORPORATION, Seoul (KR)

(72) Inventors: Uk Il Yang, Yongin-si (KR); Sang Shin Lee, Suwon-si (KR); Man Ju Oh, Yongin-si (KR)

(21) Appl. No.: 17/738,701

(22) Filed: May 6, 2022

(30) Foreign Application Priority Data
Sep. 3, 2021 (KR) 10-2021-0117790

(51) Int. Cl. B60H 1/32; B60H 1/00

(52) U.S. Cl. CPC B60H 1/3228; B60H 1/00278; B60H 1/00385

(57) ABSTRACT

A thermal management system includes an interior air conditioner including a housing provided with a cooling duct, a heating duct, an inside air inlet, an outside air inlet, and an internal outlet, and an external outlet, wherein the internal outlet of the housing is connected to an inside the vehicle and the external outlet is connected to an outside of a vehicle, an evaporation core is provided in the cooling duct of the housing, a condensing core is provided in the heating duct of the housing, air conditioning of the inside the vehicle is performed through the evaporation core and the condensing core. The evaporation core and the condensing core are connected to a refrigerant line provided with a compressor and an expansion valve and connected to multiple electronic components of the vehicle through a coolant.

### CROSS REFERENCE TO RELATED APPLICATIONS

The present application claims priority to Korean Patent Application No. 10-2021-0117790, filed Sep. 3, 2021, the entire contents of which is incorporated herein for all purposes by this reference.

### BACKGROUND

### Field

The present disclosure relates to a thermal management system for a vehicle, including a cooling duct provided with an evaporation core, a heating duct provided with a condensing core, and an interior air conditioner for performing air conditioning inside the vehicle.

### Description of the Related Art

In general, an air conditioner of a vehicle refers to a device that cools or heats the air inside the vehicle for cooling or heating. In addition to cooling and heating, air conditioning inside of the vehicle requires an outside air mode and an inside air mode depending on whether air outside the vehicle is used inside the vehicle during cooling and heating.

Conventional vehicles are provided with an air conditioner called HVAC on the dashboard in front of the first-row seat. Through this, the internal and external air modes of the vehicle and interior cooling and heating are performed. However, technologies related to electric vehicles have been developing rapidly recently. In the case of electric vehicles, air conditioning inside the vehicle is driven through batteries rather than internal combustion engines, so it is important to improve power efficiency and thermal efficiency. In addition, vehicle assembly and productivity can be improved by minimizing or modularizing parts used for vehicle air conditioning and securing ample interior space.

Therefore, is a need to develop a thermal management system with higher thermal efficiency by implementing an internal and external air mode and a cooling and heating mode of a vehicle through a compact and modular air conditioner and efficient cooling of an indoor space using heat of an electronic driving unit and a battery.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a heat management system for a vehicle with high thermal efficiency by connecting an interior air conditioner to a refrigerant line and a plurality of electronic component coolant lines to perform heating through a heat pump, which includes a cooling duct provided with an evaporation core and a heating duct provided with a condensing core, in which air conditioning of the vehicle interior space is performed through the evaporation core and the condensing core.

In order to achieve the above objective, according to one aspect of the present disclosure, there is provided a thermal management system for a vehicle, the thermal management system including an interior air conditioner includes a housing provided with a cooling duct, a heating duct, an inside air inlet, an outside air inlet, and an internal outlet, and an external outlet, wherein the internal outlet of the housing is connected to an inside the vehicle and the external outlet is connected to an outside of a vehicle, an evaporation core is provided in the cooling duct of the housing, a condensing core is provided in the heating duct of the housing, air conditioning of the inside the vehicle is performed through the evaporation core and the condensing core, and the evaporation core and the condensing core are connected to a refrigerant line provided with a compressor and an expansion valve and connected to multiple electronic components of the vehicle through a coolant. The inside air inlet and the outside air inlet may be branched and merged to the upstream parts of the cooling duct and the heating duct, respectively, and the downstream parts of the cooling duct and the heating duct may be branched and merged to the internal outlet and the external outlet, respectively.

First and second doors are provided at the points where the inside air inlet and the outside air inlet are branched and merged to the upstream parts of the cooling duct and the heating duct, respectively. The first and second doors may selectively open and close the flow path at the inside air inlet side, or the flow path at the outside air inlet side, thereby controlling gas flowing into the cooling duct and the heating duct to flow from the inside air or the outside air.

Third and fourth doors are provided at the points where downstream parts of the cooling duct and the heating duct are branched and merged into the internal and external outlets, respectively. The third and fourth doors may selectively open and close the internal outlet side flow path or the external outlet side flow path, thereby controlling gas discharged from the cooling duct and the heating duct to discharge to the inside the vehicle or the outside of the vehicle.

The heating duct is connected to the internal outlet through a mixed flow path branching from the downstream part of the heating duct and merging the internal outlet, and the mixed flow path may be formed to have a narrower outlet side width than the inlet side.

The evaporation core and the condensing core are provided with a coolant flow path through which the coolant flows, a refrigerant flow path exchanging heat with the coolant flow path, and a heat dissipation unit exchanging heat with the refrigerant flow path. One or more of the coolant flow paths, the refrigerant flow path, and the heat dissipation unit may be stacked and exchanged heat with each other.

The coolant flow path and the refrigerant flow path may be formed in a cylindrical shape, and the refrigerant flow path is arranged to surround the coolant flow path outside the coolant flow path so that the refrigerant and the coolant exchange heat. The heat dissipation unit may be provided outside the refrigerant flow path so that the refrigerant in the refrigerant flow path exchanges heat with air.

The coolant flow path and the refrigerant flow path may be formed in a plate shape, and the plurality of refrigerant flow paths is arranged to surround the coolant flow path at the upper and lower sides of the coolant flow path respectively so that the refrigerant and the coolant exchange heat. The heat dissipation unit may be provided outside the refrigerant flow path so that the refrigerant in the refrigerant flow path exchanges heat with air.

The refrigerant line connected to the interior air conditioner allows the refrigerant to flow sequentially through the compressor, condensing core, expansion valve, and evaporation core, and the refrigerant may be compressed in the compressor, condensed in the condensing core, expanded in the expansion valve, and evaporated in the evaporation core.

The interior air conditioner is connected to the electronic element coolant line that allows the coolant to circulate in the electronic driving part of the vehicle, and the battery coolant line that allows the coolant to circulate the battery of the vehicle. The coolant flowing into the interior air conditioner through the electronic element coolant line or the battery coolant line may circulate through the evaporation core or the condensing core.

A first control valve connecting the evaporation core, the electronic element coolant line, and the battery coolant line is provided at an upstream point of the evaporation core. The first control valve is provided inside or outside the interior air conditioner housing. By opening and closing the port on the electronic element coolant line side, or the port on the battery coolant line side according to the air conditioning mode of the vehicle interior space, coolant discharged from the electronic element coolant line or the battery coolant line may flow into the evaporation core.

A second control valve connecting the condensing core, the evaporation core, and the electronic element coolant line is provided at a downstream point of the condensing core. The second control valve is provided inside or outside the interior air conditioner housing. By opening and closing the port on the evaporative core side or the port on the electronic element coolant line side according to the air conditioning mode, the coolant discharged from the condensing core or the evaporative core may flow into the electronic element coolant line.

According to the thermal management system for a vehicle of the present disclosure, a cooling duct provided with an evaporation core and a heating duct provided with a condensing core are provided, and an interior air conditioner for performing air conditioning of an inside space of the vehicle through the evaporation core and the condensing core is included. In addition, the interior air conditioner is connected to a refrigerant line and a plurality of electronic component coolant lines to perform heating through a heat pump, thereby implementing a system with very high thermal efficiency.

### BRIEF DESCRIPTION OF THE FIGURES

The above and other objectives, features, and other advantages of the present disclosure will be more clearly understood from the following detailed description when taken in conjunction with the accompanying drawings, in which:

FIG. 1 is a view schematically illustrating a thermal management system for a vehicle according to an embodiment of the present disclosure.

FIG. 2 is a view schematically illustrating a thermal management system for a vehicle according to another embodiment of the present disclosure.

FIG. 3 is a view schematically illustrating an evaporation core and a condensing core in a vehicle thermal management system according to an embodiment of the present disclosure.

FIG. 4 is a view schematically illustrating an evaporation core and a condensing core in a vehicle thermal management system according to another embodiment of the present disclosure.

FIG. 5 is a view illustrating that the interior air conditioner of the thermal management system for a vehicle is connected to a refrigerant line, an electronic element coolant line, and a battery coolant line according to an embodiment of the present disclosure.

FIG. 6 is a view illustrating that the interior air conditioner of the thermal management system for a vehicle is connected to a refrigerant line, an electric vehicle coolant line, and a battery coolant line according to another embodiment of the present disclosure.

### DETAILED DESCRIPTION

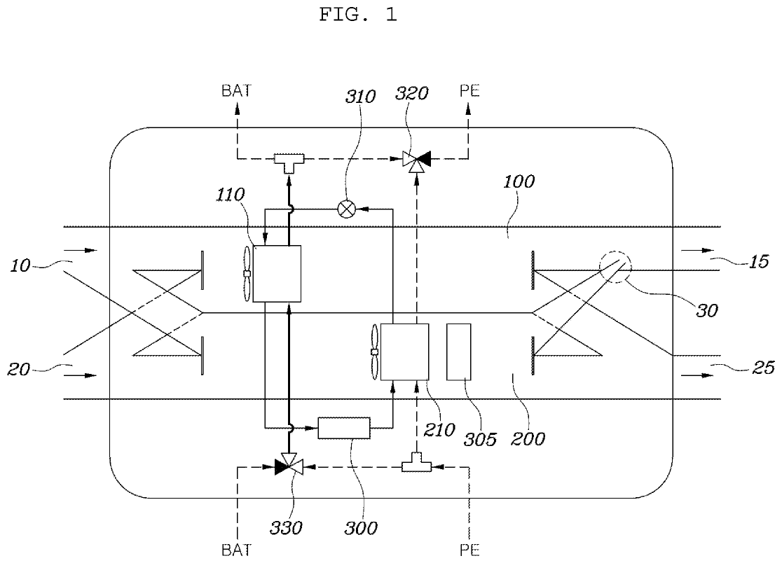

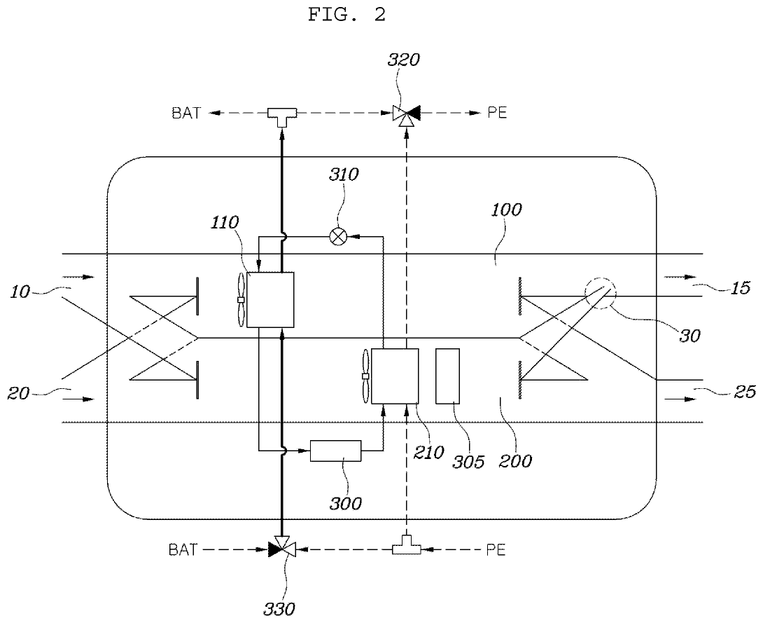

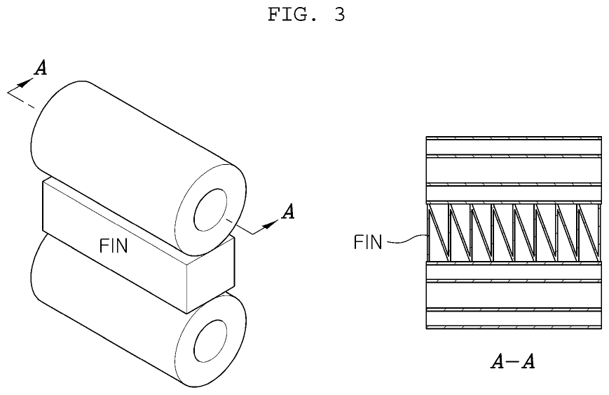

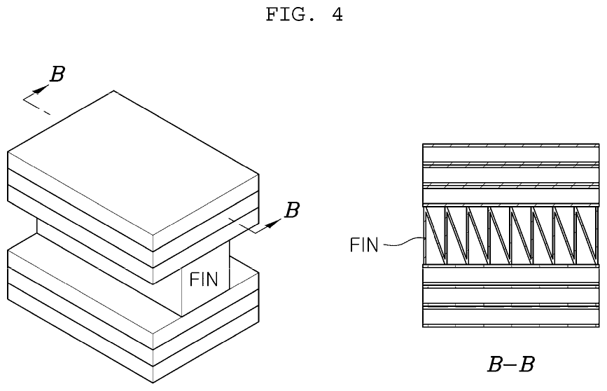

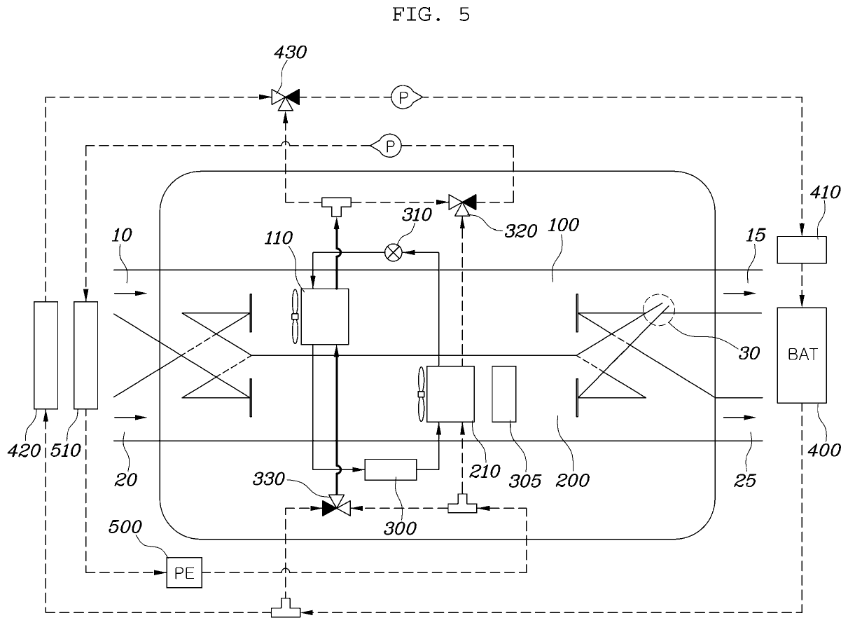

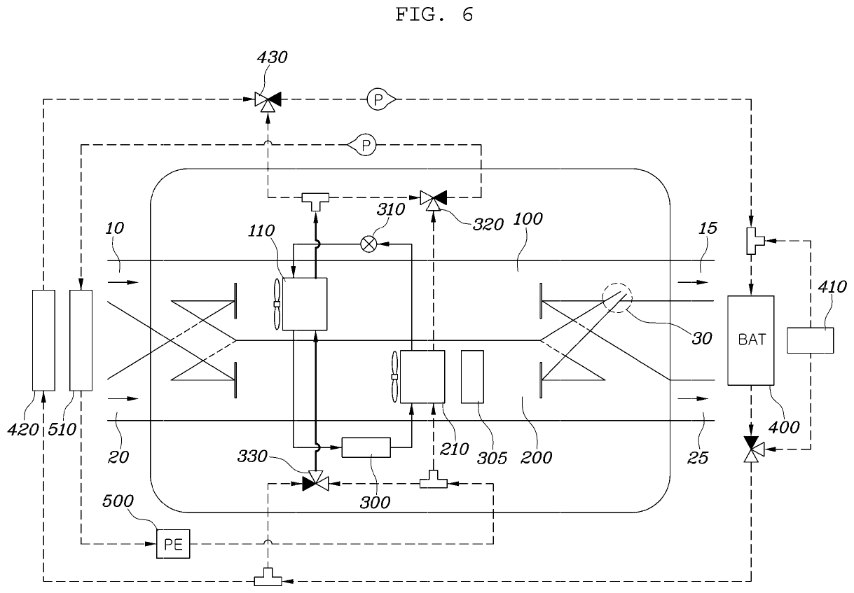

FIG. 1 is a view schematically illustrating a thermal management system for a vehicle according to an embodiment of the present disclosure. FIG. 2 is a view schematically illustrating a thermal management system for a vehicle according to another embodiment of the present disclosure. FIG. 3 is a view schematically illustrating an evaporation core and a condensing core in a vehicle thermal management system according to an embodiment of the present disclosure. FIG. 4 is a view schematically illustrating an evaporation core and a condensing core in a vehicle thermal management system according to another embodiment of the present disclosure. FIG. 5 is a view illustrating that the interior air conditioner of the thermal management system for a vehicle is connected to a refrigerant line, an electronic element coolant line, and a battery coolant line according to an embodiment of the present disclosure. FIG. 6 is a view illustrating that the interior air conditioner of the thermal management system for a vehicle is connected to a refrigerant line, an electric vehicle coolant line, and a battery coolant line, according to another embodiment of the present disclosure.

FIG. 1 is a view schematically illustrating a thermal management system for a vehicle according to an embodiment of the present disclosure. FIG. 2 is a view schematically illustrating a thermal management system for a vehicle according to another embodiment of the present disclosure. The thermal management system illustrated in FIGS. 1 and 2 may be implemented as a single module. According to an embodiment of the present disclosure, a thermal management system for a vehicle includes an interior air conditioner that includes a housing provided with a cooling duct 100, a heating duct 200, an inside air inlet 10, an outside air inlet 20, an internal outlet 15, and an external outlet 25. The internal outlet 15 of the housing is connected to an inside the vehicle and the external outlet 25 is connected to an outside of a vehicle. An evaporation core 110 is positioned in the cooling duct 100 of the housing, and a condensing core 210 is positioned in the heating duct 200 of the housing. Air conditioning of the inside the vehicle is performed through the evaporation core 110 and the condensing core 210, and the evaporation core 110 and the condensing core 210 are connected to a refrigerant line through a coolant provided with a compressor 300 and an expansion valve 310 and connected to multiple electronic components of the vehicle.

In addition, as will be described in detail below, FIGS. 1 and 2 are views illustrating a difference between the first control valve 330 and the second control valve 320 that is modularized inside the housing of the interior air conditioner, or separately provided outside the housing according to an assembly process or a vehicle structure.

On the other hand, according to an embodiment of the present disclosure, the thermal management system for a vehicle can be applied to an electric vehicle. In the case of an electric vehicle, the vehicle air conditioner is changed from the cabin room of the vehicle to the electronic driving unit, and the air conditioner is used for battery cooling and cabin room cooling. Efforts to minimize AER reduction (using a pump, optimizing air conditioning/cooling linkage) are required during cooling and heating, and the need to minimize vehicle prices through cost reduction and modularization is required to popularize electric vehicles.

Therefore, according to an embodiment of the present disclosure, the thermal management system for a vehicle minimizes additional parts through modularization of the air conditioning system, enables optimization control of air conditioning/cooling linkage with one controller. As the refrigerant circuit is located on the electronic driving unit, it is possible to use the R290 refrigerant, which has excellent performance at lower outside temperature compared to the existing 1234yf refrigerant, in the heat pump module by implementing the basic circuit, so it has the advantage of minimizing the AER reduction when using heating.

Specifically, in the vehicle thermal management system, according to an embodiment of the present disclosure, the inside air inlet 10 and the outside air inlet 20 are branched and merged to upstream parts of the cooling duct 100 and the heating duct 200, respectively, and downstream parts of the cooling duct 100 and the heating duct 200 are branched and merged to the internal outlet 15 and the external outlet 25, respectively.

In addition, in the vehicle thermal management system, according to an embodiment of the present disclosure, a first door and a second door are provided at a point where the inside air inlet 10 and the outside air inlet 20 are branched and merged into the upstream parts of the cooling duct 100 and the heating duct 200, respectively, and the first door and the second door selectively open and close a flow path of the inside air inlet 10 or a flow path of the outside air inlet 20, thereby controlling gas flowing into the cooling duct 100 and the heating duct 200 to flow from the interior space of the vehicle or the outside of the vehicle.

On the other hand, in the thermal management system for a vehicle, according to an embodiment of the present disclosure, a third door and a fourth door are provided at a point where downstream parts of the cooling duct 100 and the heating duct 200 are branched and merged into the internal outlet 15 and the external outlet 25, respectively, and the third door and the fourth door selectively open and close a flow path of the internal outlet 15 or a flow path of the external outlet 25, thereby controlling gas discharged from the cooling duct and the heating duct to be discharged to the interior space of the vehicle or the outside of the vehicle.

That is, each of the cooling duct 100 and the heating duct 200 is composed of one flow path, and the inside air inlet 10 and the outside air inlet 20 are branched and merged to each duct to implement an internal and external air mode through the door control. Similarly, the gas passing through the cooling duct 100 and the heating duct 200 is discharged to the inside the vehicle or the outside under the control of the third and the fourth doors as necessary.

In addition, in the vehicle thermal management system, according to an embodiment of the present disclosure, the heating duct 200 is connected to the internal outlet 15 through a mixing flow path that is branched from the downstream part of the heating duct 200 and merged into the internal outlet 15, and the mixing flow path 30 is formed to have a narrower width at an outlet side than at an inlet side. Since the gas heated through the condensing core 210 is mixed with the gas cooled through the evaporation core 110 through the mixing flow path 30, a mild cooling or heating mode may be implemented in the interior of the vehicle according to the temperature desired the user. The formation of the outlet side width of the mixing flow path 30 to be narrower than the inlet side width, which is formed in an orifice-like shape, has the effect of preventing backflow of air and facilitating mixing of heated gas and cooled gas.

FIG. 3 is a view schematically illustrating an evaporation core and a condensing core in a vehicle thermal management system according to an embodiment of the present disclosure. FIG. 4 is a view schematically illustrating an evaporation core and a condensing core in the vehicle thermal management system according to another embodiment of the present disclosure. In the thermal management system for a vehicle, according to an embodiment of the present disclosure, the evaporation core 110 and the condensing core 210 may be provided with a coolant flow path through which the coolant flows, a refrigerant flow path exchanges heat with the coolant flow path, and a heat dissipation unit exchanges heat with the refrigerant flow path, and one or more of the coolant flow path, the refrigerant flow path, and the heat dissipation unit are stacked to exchange heat with each other.

Specifically, in the thermal management system for a vehicle, according to an embodiment of the present disclosure, the coolant flow path and the refrigerant flow path are formed in a cylindrical shape, and the refrigerant flow path is arranged to surround the coolant flow path outside the coolant flow path, thereby exchanging heat between the refrigerant and the coolant. The heat dissipation unit may be provided outside the refrigerant flow path so that the refrigerant in the refrigerant flow path exchanges heat with air. Referring to FIG. 3, a cylindrical coolant flow path can be identified at the upper end and the lower end centering on the heat dissipation unit composed of plate fins and a cylindrical coolant flow path is also identified at the center of the cylindrical coolant flow path. Accordingly, the coolant in the coolant flow path is heat-exchanged only with the refrigerant in the refrigerant flow path, and only the refrigerant in the coolant flow path is heat-exchanged with the air passing through plate fins of the heat dissipation unit.

In addition, in the thermal management system for a vehicle, according to an embodiment of the present disclosure, the coolant flow path and the refrigerant flow path are formed in a plate shape, and the plurality of refrigerant flow paths are arranged to surround the coolant flow path at the upper and lower sides of the coolant flow path, respectively so that the refrigerant and the coolant exchange heat with each other. The heat dissipation unit may be provided outside the refrigerant flow path so that the refrigerant in the refrigerant flow path exchanges heat with air. Referring to FIG. 4, a plate-shaped refrigerant flow path can be identified at the upper and lower ends portions centering on the heat dissipation unit composed of plate fins, and at the upper end and lower end portions, a coolant flow path provided between the two plate-shaped refrigerant flow paths and the two refrigerant flow paths is identified, respectively. Accordingly, in this case, the coolant in the coolant flow path exchanges heat with only the refrigerant in the coolant flow path. Only the refrigerant in the coolant flow path exchanges heats with air passing through plate fins of the heat dissipation unit.

FIG. 5 is a view illustrating that the interior air conditioner of the thermal management system for a vehicle is connected to a refrigerant line, an electronic element coolant line, and a battery coolant line according to an embodiment of the present disclosure. FIG. 6 is a view illustrating that the interior air conditioner of the thermal management system for a vehicle is connected to a refrigerant line, an electronic element coolant line, and a battery coolant line according to another embodiment of the present disclosure. In the vehicle thermal management system, according to an embodiment of the present disclosure, in the refrigerant line to which the interior air conditioner is connected, the refrigerant sequentially flows through the compressor 300, the condensing core 210, the expansion valve 310, and the evaporation core 110. The refrigerant may be compressed in the compressor 300, condensed in the condensing core 210, expanded in the expansion valve 310, and evaporated in the evaporation core 110.

In addition, in the thermal management system for a vehicle, according to an embodiment of the present disclosure, the interior air conditioner may be connected to an electronic element coolant line in which a coolant is circulating the electronic driving unit 500 of the vehicle and a battery 400 coolant line in which a coolant is circulating the battery 400 of the vehicle. The coolant flowing into the interior air conditioner through the electronic element coolant line or the battery 400 coolant line may circulate through the evaporation core 110 or the condensing core 210.

On the other hand, in the thermal management system for a vehicle, according to an embodiment of the present disclosure, a first control valve 330 connecting the evaporation core 110, the electronic element coolant line, and the battery 400 coolant line is provided at an upstream point of the evaporation core 110. The first control valve 330 is provided inside or outside the interior air conditioner housing. By opening and closing the port on the electronic element coolant line side, or the port on the battery 400 coolant line side according to the air conditioning mode of the vehicle interior space, the coolant discharged from the electronic element coolant line or the battery 400 coolant line may flow into the evaporation core 110.

In addition, in the thermal management system for a vehicle according to an embodiment of the present disclosure, the second control valve 320 connecting the condensing core 210, the evaporation core 110, and the electronic element coolant line is provided at the downstream point of the conditioning core 210. The second control valve 320 is provided inside or outside the interior air conditioner housing. By opening and closing the port on the evaporation core 110 side, or the port on the electronic element coolant line side according to the air conditioning mode of the vehicle interior space, the coolant discharged from the condensing core 210 or the evaporation core 110 may flow into the electronic element coolant line.

In addition, the thermal management system for a vehicle according to an embodiment of the present disclosure may further include an electric heater 305, a coolant heater 410, a battery radiator 420, a three-way valve 430, and an electronic element radiator 510.

Although shown and described with respect to specific embodiments of the present disclosure, it will be apparent to those of ordinary skill in the art that the present disclosure can be variously improved and changed without departing from the technical spirit of the present disclosure provided by the following claims.

1. A thermal management system for a vehicle, the thermal management system comprising:
an interior air conditioner having a housing including a cooling duct, a heating duct, an inside air inlet, an outside air inlet, an internal outlet, and an external outlet;
wherein the internal outlet of the housing is connected to an interior space of the vehicle, and the external outlet is connected to an outside of the vehicle;
wherein the cooling duct includes an evaporation core, the heating duct includes a condensing core, air conditioning for the inside space of the vehicle is performed through the evaporation core and the condensing core, and the evaporation core and the condensing core are connected to a refrigerant line provided with a compressor and an expansion valve and are connected to multiple electronic components of the vehicle through a coolant.

2. The system of claim 1, wherein the inside air inlet is branched and merged to an upstream part of the cooling duct, the outside air inlet is branched and merged to an upstream part of the heating duct, a downstream part of the cooling duct is branched and merged to the internal outlet, and a downstream part of the heating duct is branched and merged to the external outlet.

3. The system of claim 2, wherein a first door is positioned at a point where the inside air inlet is branched and merged to the upstream part of the cooling duct, and a second door is positioned at a point where the outside air inlet is branched and merged into the upstream part of the heating duct, the first door and the second door each being configured to selectively open and close a flow path of the inside air inlet or a flow path of the outside air inlet, thereby controlling gas flowing into the cooling duct and the heating duct to flow from the interior space of the vehicle or the outside of the vehicle.

4. The system of claim 2, wherein a third door is positioned at a point where the downstream part of the cooling duct is branched and merged into the internal outlet, and a fourth door is positioned at a point where the downstream part of the heating duct is branched and merged into the external outlet, the third door and the fourth door each being configured to selectively open and close a flow path of the internal outlet or a flow path of the external outlet, thereby controlling gas discharged from the cooling duct and the heating duct to be discharged to the interior space of the vehicle or the outside of the vehicle.

5. The system of claim 2, wherein the heating duct is connected to the internal outlet through a mixing flow path that is branched from the downstream part of the heating duct and merged into the internal outlet, the mixing flow path being configured to have a narrower width at an outlet side than at an inlet side.

6. The system of claim 1, wherein the evaporation core and the condensing core are provided with a coolant flow path through which the coolant flows, a refrigerant flow path exchanging heat with the coolant flow path, and a heat dissipation unit exchanging heat with the refrigerant flow path, and one or more of the coolant flow path, the refrigerant flow path, and the heat dissipation unit are stacked to exchange heat with each other.

7. The system of claim 6, wherein the coolant flow path and the refrigerant flow path are formed in a cylindrical shape, and the refrigerant flow path is arranged to surround the coolant flow path at an outside of the coolant flow path so that the refrigerant and the coolant exchange heat with each other, and the heat dissipation unit is provided at an outside of the refrigerant flow path so that the refrigerant in the refrigerant flow path exchanges heat with air.

8. The system of claim 6, wherein the coolant flow path and the refrigerant flow path are formed in a plate shape, and a plurality of refrigerant flow paths are arranged to surround the coolant flow path at upper and lower sides of the coolant flow path, so that the refrigerant and the coolant exchange heat with each other, and the heat dissipation unit is provided at an outside the refrigerant flow path so that the refrigerant in the refrigerant flow path exchanges heat with air.

9. The system of claim 1, wherein in the refrigerant line to which the interior air conditioner is connected, refrigerant sequentially flows through the compressor, the condensing core, the expansion valve, and the evaporation core, and the refrigerant is compressed in the compressor, condensed in the condensing core, expanded in the expansion valve, and evaporated in the evaporation core.

10. The system of claim 1, wherein the interior air conditioner is connected to an electronic element coolant line in which coolant circulates in an electronic driving unit of the vehicle, and a battery coolant line in which the coolant circulates in a battery of the vehicle, and the coolant which flows into the interior air conditioner through the electronic element coolant line or the battery coolant line circulates in the evaporation core or the condensing core.

11. The system of claim 10, wherein a first control valve connecting the evaporation core, the electronic element coolant line, and the battery coolant line is positioned at an upstream point of the evaporation core, the first control valve being provided inside or outside the housing of the interior air conditioner, and the coolant discharged from the electronic element coolant line or from the battery coolant line flows into the evaporation core by opening and closing a port of an electronic element coolant line side or a port of a battery coolant line side according to an air conditioning mode of the interior space of the vehicle.

12. The system of claim 10, wherein a second control valve connecting the condensing core, the evaporation core, and the electronic element coolant line is positioned at a downstream point of the condensing core, the second control valve being provided inside or outside the housing of the interior air conditioner, and the coolant discharged from the condensing core or the evaporation core flow into the electronic element coolant line by opening and closing a port of an evaporation core side or a port of an electronic element coolant line side according to an air conditioning mode of the interior space of the vehicle.
